(19) United States
(12) Patent Application Publication
(10) Pub. No.: US 2014/0203199 A1
(43) Pub. Date: Jul. 24, 2014

(54) AUTOMATIC WATER DRAINING DEVICE FOR AIR COMPRESSOR

(71) Applicant: CHUNG-SHEN TSAI, Taichung City (TW)

(72) Inventor: CHUNG-SHEN TSAI, Taichung City (TW)

(21) Appl. No.: 13/749,651

(22) Filed: Jan. 24, 2013

(51) Int. Cl. F16K 31/02

(52) U.S. Cl. CPC F16K 31/02
USPC 251/129.01

(57) ABSTRACT

The automatic water draining device for an air compressor contains an extension pipe having a first end connected to an outlet of the air compressor's air tank; a flow control valve connected to a second end of the extension pipe for controlling the amount of flow through the extension pipe; an electromagnetic valve connected to the second end of the extension pipe; and a circuit board electrically connected to the electromagnetic valve. The circuit board controls the electromagnetic valve so that, when the air compressor is started, the electromagnetic valve is opened for 3 to 5 seconds and then closed, and as such the water and debris accumulated in the air tank is drained.

### TECHNICAL FIELD OF THE INVENTION

The present invention is generally related to air compressors and more particular to an automatic water draining device for draining the accumulated water and debris in an air compressor.

### DESCRIPTION OF THE PRIOR ART

An air compressor draws in outside air and then outputs compressed air. In the process, water and debris contained in the air are accumulated in an air tank of the air compressor. The water and debris have to be removed daily or periodically. Conventionally, a release valve is configured at the bottom of the air tank's bottom, and has to be opened and closed manually so as to drain the water and debris. This manual operation is obviously not efficient, and inevitably people forget to perform such manual operation. Therefore, how to resolve the inefficiency of manually draining air compressor's accumulated water is a key issue to air compressor manufacturers.

### SUMMARY OF THE INVENTION

In order to resolve the problems of manually draining air compressor's accumulated water and operator absentmindedness, the present invention provides an automatic water draining device for an air compressor. Whenever an air compressor is started, the automatic water draining device automatically drains the accumulated water in the air compressor, so as to enhance the air compressor's air quality, to prolong its operational life span, and to improve the inefficiency of manual draining.

Therefore, the present invention provides an automatic water draining device for an air compressor, which contains an extension pipe having a first end connected to an outlet of the air compressor's air tank; a flow control valve connected to a second end of the extension pipe for controlling the amount of flow through the extension pipe; an electromagnetic valve connected to the second end of the extension pipe; and a circuit board electrically connected to the electromagnetic valve. The circuit board controls the electromagnetic valve so that, when the air compressor is started, the electromagnetic valve is opened for 3 to 5 seconds and then closed, and as such the water and debris accumulated in the air tank is drained. The amount of drainage is controlled by the flow control valve.

A major objective of the present invention is to provide an automatic water draining device for an air compressor where, whenever the air compressor is started, the water accumulated in an air tank of the air compressor is automatically drained for 3 to 5 seconds, so as to improve the inefficiency of manual draining without complex structure, installation, and manual operation.

Another objective of the present invention is to provide an automatic water draining device for an air compressor where the automatic drainage of the air compressor is controlled by a flow control valve adjustable based on the capacity of the air tank of the air compressor so as to decrease the amount of compressed air lost along with the drained water. The efficiency of the air compressor is therefore not compromised by the automatic water draining device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of an automatic water draining device according to an embodiment of the present invention.

FIG. 2 is a perspective diagram showing the automatic water draining device of FIG. 1 after its assembly.

FIG. 3 is a perspective diagram showing the configuration of the automatic water draining device of FIG. 1 to an air compressor.

FIG. 4 is a side-view diagram showing the automatic water draining device and the air compressor of FIG. 3.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

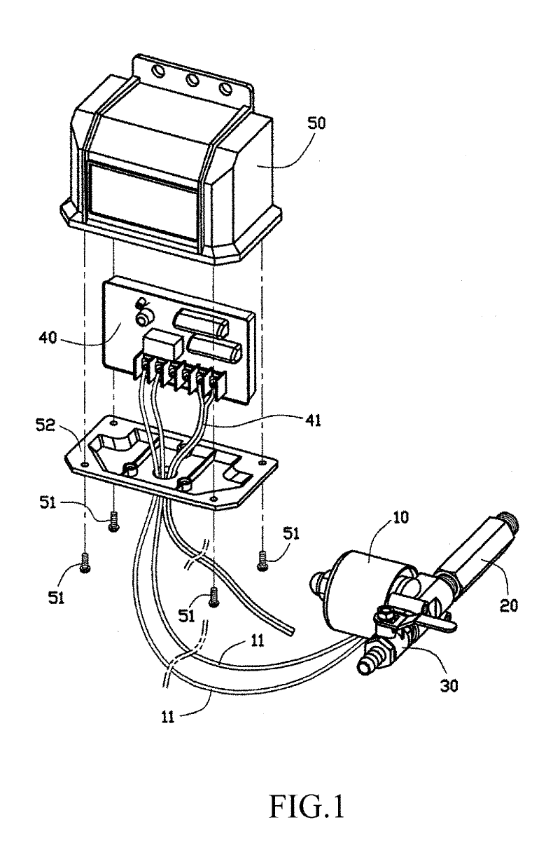

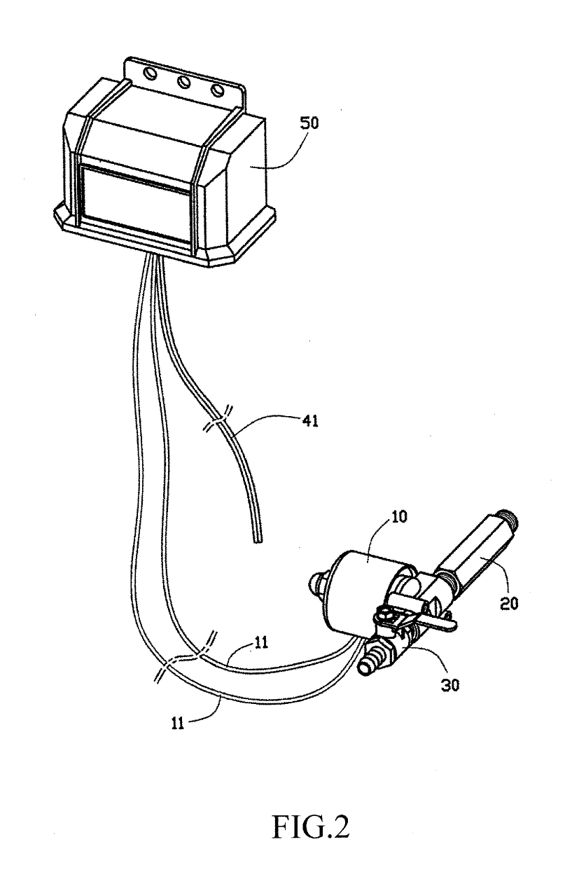

As shown in FIGS. 1 and 2, an automatic water draining device for an air compressor according to an embodiment of the present invention contains an electromagnetic valve 10 connected to an end of an extension pipe 20. The end of the extension pipe 20 is also connected to a flow control valve 30 for controlling the amount of flow through the extension pipe 20. The electromagnetic valve 10 is connected to a circuit board 40 through wires 11, and is controlled by the circuit board 40 to be opened for about 3 to 5 seconds and then closed.

The circuit board 40 is populated with electronic components (not shown). The circuit board 40 is placed in a casing 50 and then the casing 50 is sealed with a bottom cover 52 by bolts 51. The circuit board 40 is connected to the electromagnetic valve 10 by wires 11. The circuit board 40 drives the electromagnetic valve 10 so that the electromagnetic valve 10 is opened for about 3 to 5 seconds and then closed.

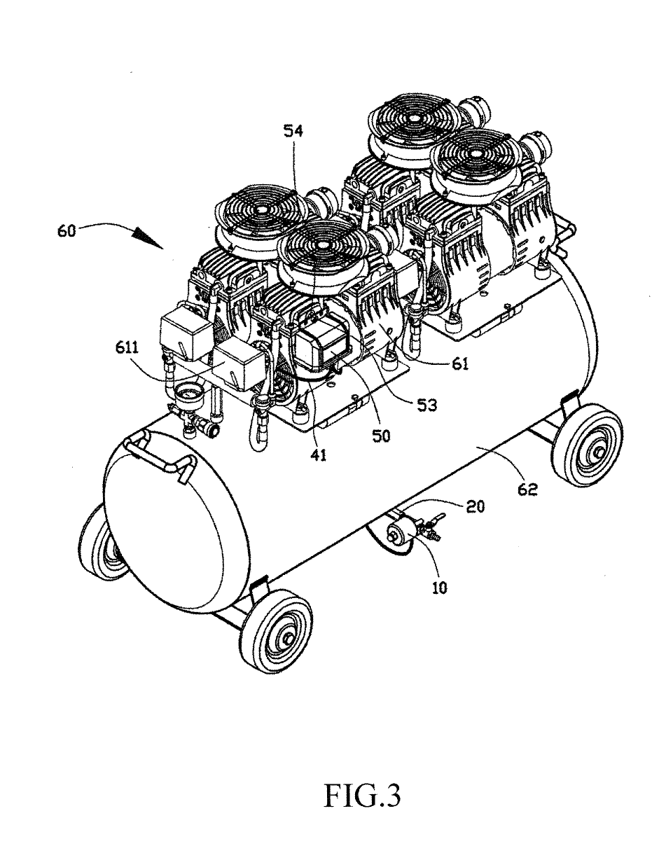

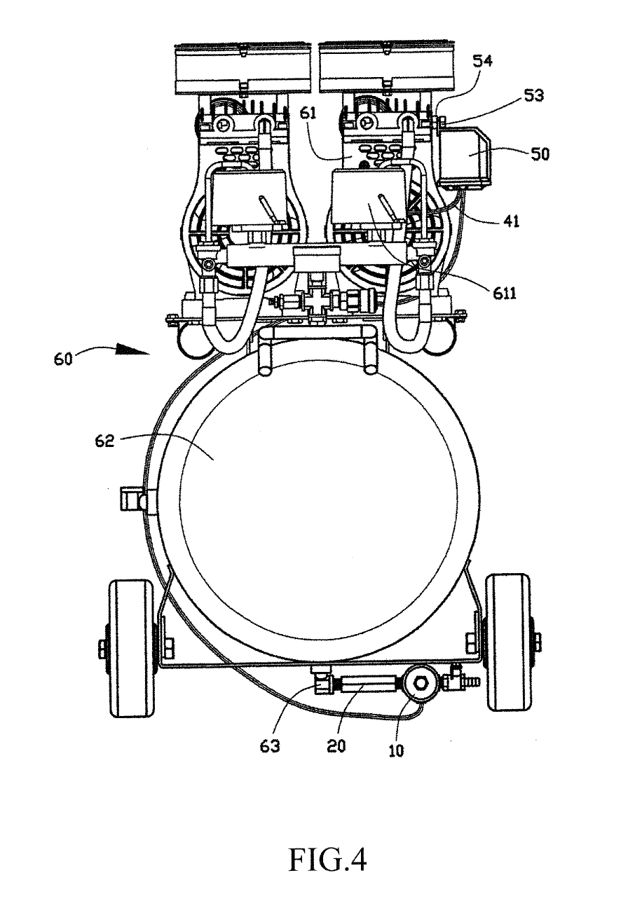

As further shown in FIGS. 3 and 4, an application scenario of the automatic water draining device is as follows. The casing 50 having the circuit board 40 inside is configured to a side of a compressing device 61 of an air compressor 60. By bolts 53 and nuts 54. A power cable 41 from the circuit board 40 is connected to a power switch box 611 of the compressing device 61 for drawing the required electrical power. The extension pipe 20 is then connected an outlet 63 of an air tank 62 of the air compressor 60. The operation of the automatic water draining device is described as follows. Every time when the compressing device 61 of the air compressor 60 is started, the circuit board 40 drives the electromagnetic valve 10 to open for about 3 to 5 seconds so that the water and debris accumulated in the air tank 62 is drained. The amount of drainage is controlled by the flow control valve 30 adjustable based on the capacity of the air tank 62 of the air compressor 60 so as to decrease the amount of compressed air lost along with the drained water. As such, the automatic water draining device provides automated water draining without complex structure, installation, and manual operation.

Please note that the electronic components (not shown) on the circuit board 40, as well as the details about the air compressor 60, should be familiar to people of the related art. No specific limitation is imposed on these components, and their details are omitted.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic water draining device for an air compressor having a compressing device, an air tank, and a switch box, comprising:
an extension pipe having a first end connected to an outlet of the air tank;
a flow control valve connected to a second end of the extension pipe for controlling the amount of flow through the extension pipe;
an electromagnetic valve connected to the second end of the extension pipe; and
a circuit board electrically connected to the electromagnetic valve and the switch box;
wherein, when the air compressor is started, circuit board controls the electromagnetic valve so that the electromagnetic valve is opened for a period of time and then closed, and as such the water and debris accumulated in the air tank is drained.
